(19) United States
(12) Patent Application Publication
(10) Pub. No.: US 2010/0116996 A1
(43) Pub. Date: May 13, 2010

(54) DETECTOR WITH A PARTIALLY TRANSPARENT SCINTILLATOR SUBSTRATE

(75) Inventor: Tiemen Poorter, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/596,844

(22) PCT Filed: Apr. 17, 2008
(86) PCT No.: PCT/IB08/51469

§ 371 Date: Oct. 21, 2009

(30) Foreign Application Priority Data
Apr. 23, 2007 (EP) 07106737.5

(51) Int. Cl. G01T 1/20; B05D 5/06

(52) U.S. Cl. 250/368; 427/162

(57) ABSTRACT

Detector with a partially transparent scintillator substrate According to an exemplary embodiment of the present invention, a flat detector is provided in which an opaque layer between a transparent substrate and a CsI scintillator is arranged. This layer is made partially transparent by opening many small holes in the opaque layer with for example a pulsed laser. This allows for the application of light to the inside of the front end of the flat detector through the opaque layer.

The invention relates to the field of medical imaging. In particular, the invention relates to a detector for examination of an object of interest, to an examination apparatus and to a method for producing such a detector.

In current a-Si (a-Silicon) based flat x-ray detectors a refreshlight is often used to illuminate the photodiodes of the sensor array. The refreshlight is applied via the back of the a-Si array and it passes through the array via open areas in the pixel matrix.

When ultraviolet (UV) light is used as a refreshlight, the CsI (caesium-iodide) brightburn may also be mitigated for improving the three-dimensional reconstruction image quality.

In new types of flat x-ray detectors the substrate of the sensor array may be opaque to the intended wavelength of the refreshlight. When for instance monocrystalline silicon is used as a sensor matrix for sensing the light generated by the scintillator the substrate is completely opaque to light.

It would be desirable to have a detector with an opaque substrate, wherein the detector has an improved time behaviour.

The invention provides a detector, an examination apparatus and a method for producing such a detector with the features according to the independent claims.

It should be noted that the following described exemplary embodiments of the invention apply also for the method of producing the detector and the examination apparatus.

According to a first aspect of the present invention, a detector for examination of an object of interest with an examination apparatus is provided, the detector comprising a substrate and a reflecting layer, wherein the reflecting layer is adapted for reflecting a fraction of light generated in a scintillator towards a sensor array, and wherein the reflecting layer comprises a plurality of holes adapted for being transparent to a wavelength of refreshlight, such that the reflecting layer is partially transparent to the wavelength of the refreshlight and to the wavelength of the light from the scintillator.

It should be noted that in the context of the present invention, “substrate” refers to either “scintillator substrate” or “sensor array substrate”. If “substrate” refers to the scintillator substrate (alternative 1), the scintillator of the detector may be grown on the scintillator substrate and then glued to the sensor array. If “substrate” refers to the sensor array substrate (alternative 2), the scintillator may be grown directly on the sensor array (which in turn has been grown on the sensor array substrate). In this case no scintillator substrate has to be present.

In other words, a detector is provided which allows for the application of light from outside the detector front end (e.g. from the back of the scintillator substrate) to the inside of the front end of the detector. This refreshlight, which may be for example ultraviolet light, passes through the plurality of holes through the reflecting layer. Thus, the refreshlight may improve the brightburn of the scintillator.

The scintillator substrate is for example semitransparent in such a way that the light yield and the modulation transfer function (MTF) of the scintillator can be maintained at the required level. This may be achieved via a light transparent scintillator substrate provided with an opaque and for example light reflecting layer between the substrate and the scintillator. This layer is made partially transparent by opening many small holes in the opaque layer.

Thus, according to another exemplary embodiment of the present invention, the reflecting layer comprises a material which is opaque to the wavelength of the refreshlight.

In other words, the reflecting layer may be adapted for reflecting the light generated by the scintillator, thus improving the yield of the detector.

According to another exemplary embodiment of the present invention, the sensor array substrate is adapted as a monosilicon substrate produced on the basis of monosilicon technology.

According to another exemplary embodiment of the present invention, the sensor array comprises a plurality of pixels, wherein a size of each hole in the reflecting layer of the scintillator substrate is less than about 10% of a pixel size of a pixel of the sensor array.

According to another exemplary embodiment of the present invention, the reflecting layer has a surface, wherein a fraction of the surface of the reflecting layer is transparent to the wavelength of the refreshlight, and wherein the fraction of the surface of the reflecting layer which is transparent to the wavelength of the refreshlight is less than 30% of the surface of the reflecting layer.

Therefore, the amount of light that can be introduced to the scintillator material via the holes may be large enough to perform the required change of the scintillator and/or the sensor elements. At the same time the fraction of light that is lost from the front-end of the detector through the holes and the substrate is kept to a designed small value such that the detectors and sensitivity is only influenced to the designed level.

According to another exemplary embodiment of the present invention, the plurality of holes in the reflecting layer is produced on the basis of a laser ablation process or a lift off process.

It should be noted, however, that other kinds of processes may be used for producing the holes, such as for example dry etching techniques.

According to another exemplary embodiment of the present invention, the reflecting layer and the scintillator substrate are adapted for scattering or absorbing only a small fraction of primary radiation.

Thus, most of the radiation entering the detector passes through the reflecting layer and the scintillator substrate without being scattered or absorbed.

As materials for the reflecting layer, aluminium or silver may be used. The scintillator substrate may comprise aluminium or amorphous carbon.

According to another exemplary embodiment of the present invention, the scintillator substrate is a glass substrate, wherein the detector comprises a hard seal between the scintillator substrate and the sensor array, and wherein the hard seal is adapted for sealing the front end of the detector from the environment.

Thus, since the glass substrate and the sensor array (for example glass or silicon) have similar coefficients of thermal expansion, a hard seal can be made between the scintillator substrate and the sensor array.

According to another exemplary embodiment of the present invention, the detector is a flat detector adapted for detecting x-ray radiation.

According to still another exemplary embodiment of the present invention, an examination apparatus for examination of an object of interest is provided, the examination apparatus comprising a detector having a substrate and a reflecting layer, wherein the reflecting layer is adapted for reflecting a fraction of light generated in a scintillator towards a sensor array, and wherein the reflecting layer comprises a plurality of holes adapted for being transparent to a wavelength of refreshlight, such that the reflecting layer is partially transparent to the wavelength of the refreshlight.

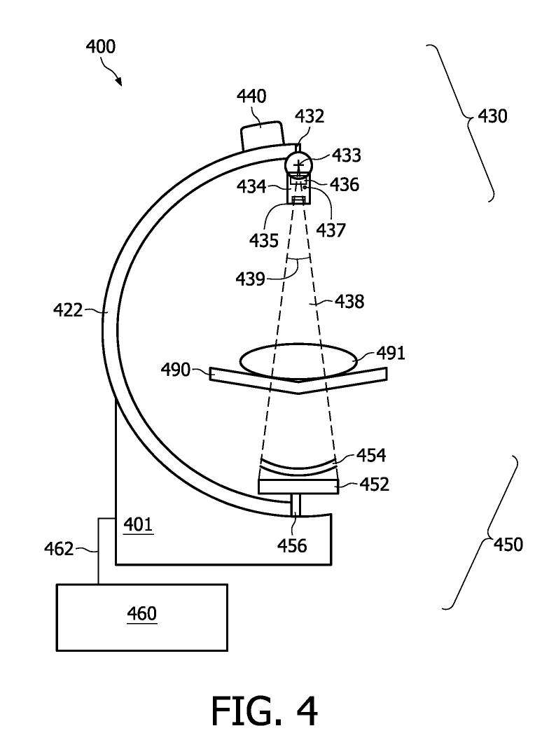

Since the detector according to the invention may have an improved and more stable sensitivity, such a detector may in particular be used in imaging applications where the X-ray source/detector arrangement is rotated around the patient (object to be analysed) while many images are taken. Then these images are used to calculate a 3-D image of the patient/object. Such an imaging apparatus is for example depicted in FIG. 4.

Furthermore, according to another exemplary embodiment of the present invention, the examination apparatus is adapted as one of a two-dimensional x-ray imaging apparatus, a computed tomography (CT) apparatus, a coherent scatter computed tomography (CSCT) apparatus, and an x-ray examination apparatus for cardiac imaging, vascular imaging or universal radiography and fluoroscopy imaging (URF imaging).

A field of application of the invention may be medical imaging or baggage inspection or non destructive testing.

According to another exemplary embodiment of the present invention, a method for producing a partially transparent substrate-reflecting layer combination for a detector for examination of an object of interest with an examination apparatus is provided, the method comprising the steps of providing a scintillator substrate, depositing a reflecting layer on the scintillator substrate and providing a plurality of holes in the reflecting layer, wherein the holes are adapted for being transparent to a wavelength of refreshlight, and wherein the reflecting layer is adapted for reflecting a fraction of light generated in a scintillator towards a sensor array.

The holes in the reflecting layer are adapted such that the combination of substrate and reflecting layer is partially transparent to the wavelength of a refreshlight.

According to another exemplary embodiment of the present invention, the method further comprises the step of changing a surface structure of the scintillator substrate on a side where a scintillator will be grown, resulting in a surface roughness for preventing a delamination of the scintillator from the substrate during use of the detector.

According to another exemplary embodiment of the present invention, a method for producing a partially transparent substrate-reflecting layer combination for a detector for examination of an object of interest with an examination apparatus is provided, the method comprising the steps of providing a sensor array substrate, depositing a sensor array on the sensor array substrate, depositing a scintillator on the sensor array, and providing a reflecting layer on the scintillator.

According to another exemplary embodiment of the present invention, the reflecting layer is adapted as one of a mirror or as white paint with small holes.

The scintillator may, for example, consist of CsI.

It may be seen as the gist of an exemplary embodiment of the present invention that a detector is provided which comprises an opaque reflecting layer on the substrate of the scintillator which is made partially transparent to refreshlight without reducing the light yield and the MTF of the scintillator layer. The reflecting layer is made partially transparent by opening many small holes in the opaque layer with for example a pulsed laser. The size of the holes is small compared to the pixel size of the sensor and the relative area of the openings is a fraction of the total area in the range of a few percent up to about 30%.

These and other aspects of the present invention will become apparent from and elucidated with reference to the embodiments described hereinafter.

Exemplary embodiments of the present invention will now be described in the following, with reference to the following drawings.

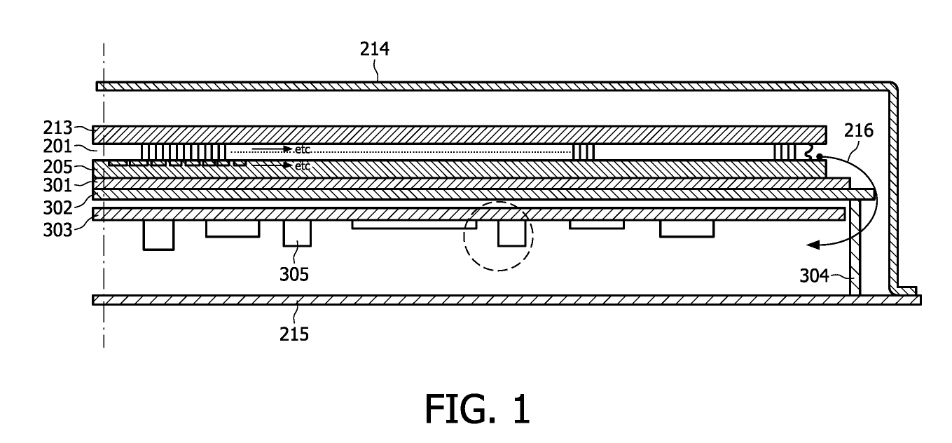

FIG. 1 shows a detector according to an exemplary embodiment of the present invention.

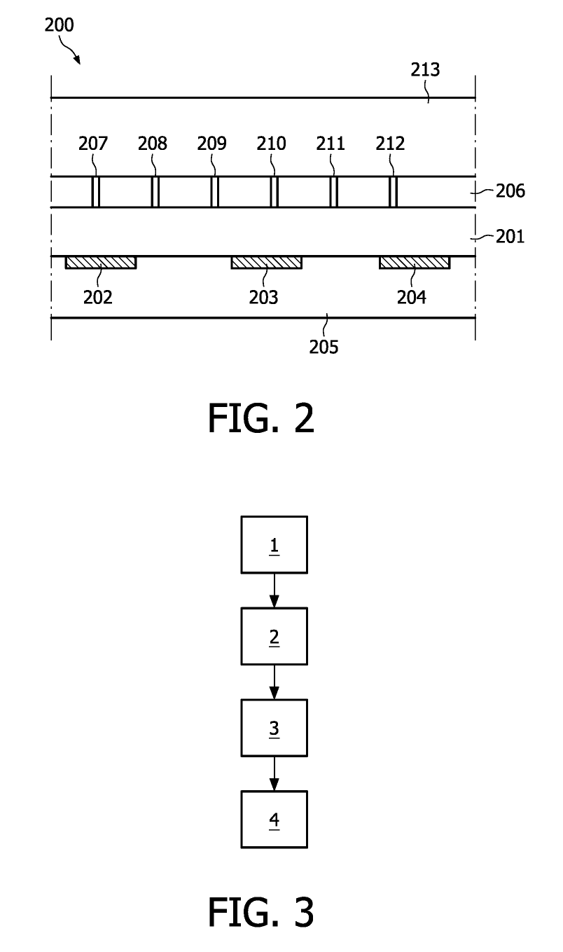

FIG. 2 shows a detector front end according to an exemplary embodiment of the present invention.

FIG. 3 shows a flow-chart of a method for producing a partially transparent substrate for a detector according to an exemplary embodiment of the present invention.

FIG. 4 shows a representation of a two-dimensional x-ray imaging apparatus according to an exemplary embodiment of the present invention.

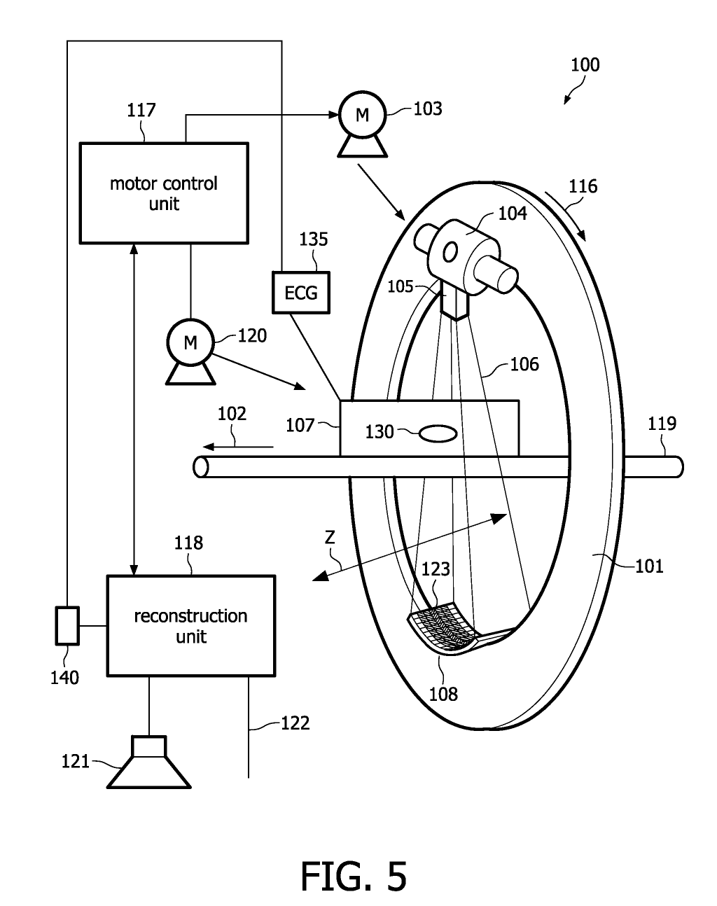

FIG. 5 shows a schematic representation of an examination apparatus according to another exemplary embodiment of the present invention.

The illustration in the drawings is schematically. In different drawings, similar or identical elements are provided with the same reference numerals.

FIG. 1 shows a schematic representation of the detector front end together with the respective electronics. As may be seen from FIG. 1, the scintillator substrate 213, the CsI scintillator 201 (between which the partially transparent, opaque/reflecting layer 206 which is depicted in FIG. 2 (but which is not depicted with respect to FIG. 1) is arranged) and the sensor array 205 are placed on a radiation shield 301, for example made of lead.

Reference numerals 302, 304 represent the electronics housing. The electronics of the detector is arranged within the housing 302, 304 and comprises a printed circuit board 303 onto which corresponding electronic elements, such as element 305, are arranged.

The detector front end 213, 201, 205 is connected to the electronics via connections 216. It should be noted that the representation depicted in FIG. 1 is only schematic and not a detailed or scaled representation.

Furthermore, an x-ray transparent detector cover 214 is provided, which, together with the back cover or ground plate 215 provides a casing for the detector.

FIG. 2 shows a schematic representation of a detector front end 200. As may be seen from FIG. 2, the front end 200 comprises, inter alia, a scintillator layer 201, a sensor array 205 comprising detecting elements or pixel 202, 203, 204 which are adapted for detecting electromagnetic radiation generated in the scintillator by x-rays.

Furthermore, the front end 200 comprises a reflecting layer 206 which comprises a plurality of small holes 207, 208, 209, 210, 211 and 212.

The reflecting layer 206 is arranged on top of the scintillator substrate 213.

The different layers 201, 202, 206 may be covered by a protection layer or by a detector cover 214. Furthermore, a hard seal may be provided between the sensor array substrate 205 and the scintillator substrate 213 to protect the scintillator 201, the reflecting layer 206 and the detecting layer 205, 202, 203, 204, 205, (not depicted in FIG. 2).

Furthermore, no electronics are depicted in FIG. 2.

The scintillator substrate (or the substrate-reflecting layer combination) of the scintillator used in x-ray flat detectors may be opaque to visual radiation and UF. This is a requirement to keep the x-ray generated light in the conversion layer so that it can be read out by the sensor matrix commonly formed by a-Si on glass.

The combination of the sensor array and the x-ray conversion layer (which may be formed of CsI) on its substrate is usually a sealed unit which forms the front end of the flat detector.

When light is applied to this front end of the x-ray flat detector for purposes of changing the properties of the a-Si photodiodes or of the CsI scintillator this may be done by applying light from the back of the a-Si glass plate. The refreshlight passes through the array via open areas in the pixel matrix.

In an other type of a flat x-ray detector the substrate of the sensor array may be opaque to the intended wavelength of the refreshlight. In that case the refreshlight may be applied using a semitransparent scintillator substrate in such a way that the light yield and MTF of the scintillator can be maintained at the required level.

Such a semitransparent scintillator substrate is depicted in FIG. 2 with respect to reference numerals 206, 213.

The functions of the scintillator substrate 206, 213 are:
A substrate onto which the scintillator material is deposited during a controlled growth process such that it acquires its required properties.
The surface properties of the substrate are important to the structure of the deposited scintillator layer.
Furthermore, the scintillator substrate 206 and 213 has to provide a carrier plate for the scintillator layer when it is part of the detector front end.
Still further, a delamination of the scintillator from the substrate after the deposition process, after post-processing or during lifetime of the flat detector has to be avoided. The properties and the preparation of the substrate are important to this capability.
Furthermore, the substrate has to provide a reflector from which a designed fraction of the light generated and the scintillator is reflected towards the sensor array.
Furthermore, the substrate material should absorb or scatter only a small fraction of the primary x-rays.

Substrate materials which may be used may consist of or comprise aluminium and/or amorphous carbon or silver. These layers are opaque to light.

The substrate 213 depicted in FIG. 2 onto which the CsI layer is grown is transparent to the light that is used to “refresh” or change/improve the behaviour of the CsI.

The partially transparent, opaque/reflecting layer 206 forms the base layer for the CsI, i.e. the substrate of the CsI.

Reference numerals 202, 203, 204 depict the pixel of the sensor array 205.

FIG. 3 shows a flow-chart of a method according to an exemplary embodiment of the present invention. The method starts at step 1 in which a glass plate is used as a starting material. Different types of glass may be possible. The same material as used for the a-Si substrate such as Borosilicate glass may be in particular applicable.

In step 2, the surface structure of the glass substrate on the side where the CsI (caesium iodide) will be grown is changed by chemical etching or sandblasting or any methods appropriate in order to give the surface a certain roughness such that the CsI layer that needs to be grown on it will not delaminate during subsequent processing or during life of the detector. This surface structure should also be adapted for promoting the columnar growth of the scintillator layer.

In step 3, a reflecting layer (for example aluminium or silver) is deposited on the roughened glass surface, for example with the help of an evaporation or chemical vapour deposition process. This layer forms an opaque and reflecting or non-reflecting separation between the glass and the CsI layer.

Then, in step 4, a large number of small holes is made in the reflecting layer by for example laser ablation. This may be performed either hole by hole or with a mask provided with a large number of holes with which a fraction of the substrate can be processed at one time.

Alternatively, the required holes are made for example with the use of a lift off technique.

Holes are much smaller than the pixel size of the sensor onto which the scintillator will be used (preferably the hole diameter is smaller than 5 to 10% of the pixel size). The pixel size will depend on the application and on the design of the detector. It may be in the range of e.g. 20 μm to ca 200 μm for high resolution detectors and in the range of 200 μm to 2 mm for e.g. pixels for detectors used in Computed Tomography.

The fraction of the surface that is transparent to light (i.e. the relative area density of the ablated reflector area) is between a small percentage and about 30%, for example between 2% and 20%. Under these conditions the amount of light that can be introduced to the scintillator material via the holes can be large enough to perform the required change of the scintillator and/or the sensor elements. At the same time the fraction of light that is lost from the front-end of the detector through the holes in the substrate is kept to a designed small value such that the detector sensitivity is only influenced to the designed level.

When light is passed through the holes in the opaque layer that is formed on the CsI substrate some of this light will be reflected in the glass plate and/or in the optical system for introducing the refreshlight. This scintillator generated light may partly re-enter the detector front end through the holes in the opaque layer and deteriorate the MTF of the detector. Also for this reason the fraction of the surface that is opened by the laser ablation should be small so that the MTF of the scintillator layer is not significantly reduced. This condition may be obtained by choosing the size and number of light transmitting area on the substrate as described in the previous point above.

An additional advantage of the use of glass as a substrate for the scintillator is that the coefficient of thermal expansion may be matched to that of the sensor array (for example glass or silicon). Under these conditions a hard seal may be made between the scintillator substrate and the sensor array to seal the front end of the detector from the environment.

As an alternative to glass as the substrate for the scintillator another material may be used that is transparent to the radiation that is required for (can be used for) refreshing the sensor array and/or changing the behaviour of the scintillator (for example Ultra Violet light for changing the time behaviour and light yield of the scintillator).

The invention may be used to introduce refreshlight in the front end of x-ray flat detectors without a negative influence on the sensitivity and the MTF of a detector with such a front end. This refreshlight may for example be used to change/improve the behaviour of the detector with respect to its signal lag over time and/or reduce/improve the change of the scintillator sensitivity after x-ray exposure (brightburn).

FIG. 4 shows a representation of a two-dimensional x-ray imaging apparatus according to an exemplary embodiment of the present invention. The imaging apparatus 400 comprises a source assembly 430 which has an x-ray power supply 440, an x-ray tube 432, a device 435 comprising two monitors 436, 437 and a collimator 434.

The focal point of the x-rays generated by the source 432 is at location 433. The x-ray beam 438 generated by the source 432 has a beam angle 439 and penetrates the object to be imaged 491 which is placed on a table 490.

The beam 438 passes an anti scatter grid 454 and is detected by detector 452 which form part of the receiver assembly 450. The detector 452 is a detector according to the invention.

Source 432 and detector 452 are arranges on a gantry 422, which may be rotatably mounted to the gantry base 401. Furthermore, a radial adjustment component 456 is provided for adjusting the detector 452 in a radial manner.

The gantry base 401 is connected with a computer system 460 via link 462 in order to allow for a control of the source assembly and a transmission of the detector data to the computer system 460.

FIG. 5 shows an exemplary embodiment of a computed tomography scanner system according to an exemplary embodiment of the present invention.

The computer tomography apparatus 100 depicted in FIG. 5 is a cone-beam CT scanner. However, the invention may also be carried out with a fan-beam geometry. In order to generate a primary fan-beam, the aperture system 105 can be configured as a slit collimator. The CT scanner depicted in FIG. 5 comprises a gantry 101, which is rotatable around a rotational axis 102. The gantry 101 is driven by means of a motor 103. Reference numeral 104 designates a source of radiation such as an X-ray source, which, according to an aspect of the present invention, emits polychromatic or monochromatic radiation.

Reference numeral 105 designates an aperture system which forms the radiation beam emitted from the radiation source to a cone-shaped radiation beam 106. The cone-beam 106 is directed such that it penetrates an object of interest 107 arranged in the center of the gantry 101, i.e. in an examination region of the CT scanner, and impinges onto the detector 108. As may be taken from FIG. 5, the detector 108 is arranged on the gantry 101 opposite to the source of radiation 104, such that the surface of the detector 108 is covered by the cone-beam 106. The detector 108 depicted in FIG. 5 comprises a plurality of detector elements 123 each capable of detecting X-rays which have been scattered by or passed through the object of interest 107.

During scanning the object of interest 107, the source of radiation 104, the aperture system 105 and the detector 108 are rotated along the gantry 101 in the direction indicated by an arrow 116. For rotation of the gantry 101 with the source of radiation 104, the aperture system 105 and the detector 108, the motor 103 is connected to a motor control unit 117, which is connected to a reconstruction unit 118 (which might also be denoted as a calculation or determination unit).

In FIG. 5, the object of interest 107 is a human being which is disposed on an operation table 119. During the scan of, e.g., the heart 130 of the human being 107, while the gantry 101 rotates around the human being 107, the operation table 119 displaces the human being 107 along a direction parallel to the rotational axis 102 of the gantry 101. By this, the heart 130 is scanned along a helical scan path. The operation table 119 may also be stopped during the scans to thereby measure signal slices. It should be noted that in all of the described cases it is also possible to perform a circular scan, where there is no displacement in a direction parallel to the rotational axis 102, but only the rotation of the gantry 101 around the rotational axis 102.

Moreover, an electrocardiogram device 135 may be provided which measures an electrocardiogram of the heart 130 of the human being 107 while X-rays attenuated by passing the heart 130 are detected by detector 108. The data related to the measured electrocardiogram are transmitted to the reconstruction unit 118.

The detector 108 is connected to the reconstruction unit 118. The reconstruction unit 118 receives the detection result, i.e. the read-outs from the detector elements 123 of the detector 108 and determines a scanning result on the basis of these read-outs. Furthermore, the reconstruction unit 118 communicates with the motor control unit 117 in order to coordinate the movement of the gantry 101 with motors 103 and 120 with the operation table 119.

The reconstruction unit 118 may be adapted for reconstructing an image from read-outs of the detector 108. A reconstructed image generated by the reconstruction unit 118 may be output to a display (not shown in FIG. 5) via an interface 122.

The reconstruction unit 118 may be realized by a data processor to process read-outs from the detector elements 123 of the detector 108.

The detector 108 comprises a substrate and a reflecting layer on the substrate, wherein the reflecting layer is adapted for reflecting a fraction of light generated in a scintillator towards a sensor array and wherein the reflecting layer comprises a plurality of holes adapted for being transparent to a wavelength of refreshlight, such that the combination of substrate and reflecting layer is partially transparent to the wavelength of the refreshlight. Detector 108 may also comprise a large number of separate pixel elements. In this case each of these pixel elements has at least one of its outside walls made out of a partially transparent reflecting material such that refresh light can be introduced into the pixel element. The refreshlight is then applied to improve the time behaviour of the pixel element and or improve the stability of the sensitivity of the pixel element over time and or after exposure to radiation

The measured data, namely the cardiac computer tomography data and the electrocardiogram data are processed by the reconstruction unit 118 which may be further controlled via a graphical user-interface (GUI) 140. This retrospective analysis may be based on a helical cardiac cone-beam reconstruction scheme using retrospective ECG gating. It should be noted, however, that the present invention is not limited to this specific data acquisition and reconstruction.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

1. Detector for examination of an object of interest with an examination apparatus, the detector comprising:
a substrate and a reflecting layer;
wherein the reflecting layer is adapted for reflecting a fraction of light generated in a scintillator towards a sensor array; and
wherein the reflecting layer comprises a plurality of holes adapted for being transparent to a wavelength of refreshlight, such that the reflecting layer is partially transparent to the wavelength of the refreshlight.

2. Detector of claim 1,
wherein the reflecting layer comprises a material which is opaque to the wavelength of the refreshlight and to the wavelength of the light generated in the scintillator.

3. Detector of claim 1,
wherein the substrate is a scintillator substrate and wherein the reflecting layer is disposed on the scintillator substrate.

4. Detector of claim 1,
wherein the sensor array comprises a plurality of pixels; and
wherein a size of each hole in the reflecting layer is less than 10% of a pixel size of a pixel of the sensor array.

5. Detector of claim 1,
wherein the reflecting layer has a surface;
wherein a fraction of the surface of the reflecting layer is transparent to the wavelength of the refreshlight; and
wherein the fraction of the surface of the reflecting layer which is transparent to the wavelength of the refreshlight is less than 30% of the surface of the reflecting layer.

6. Detector of claim 1,
wherein the plurality of holes in the reflecting layer is produced on the basis of a laser ablation process or a lift off process.

7. Detector of claim 1,
wherein the reflecting layer and the substrate are adapted for scattering or absorbing only a small fraction of primary radiation.

8. Detector of claim 1,
wherein the scintillator substrate is a glass substrate; and
wherein the detector comprises a hard seal between the scintillator substrate and the sensor array; and
wherein the hard seal is adapted for sealing the front end of the detector from the environment.

9. Detector of claim 1,
wherein the detector is a flat detector adapted for detecting x-ray radiation.

10. Examination apparatus for examination of an object of interest, the examination apparatus comprising:
a detector having a substrate and a reflecting layer;
wherein the reflecting layer is adapted for reflecting a fraction of light generated in a scintillator towards a sensor array; and
wherein the reflecting layer comprises a plurality of holes adapted for being transparent to a wavelength of refreshlight, such that the reflecting layer is partially transparent to the wavelength of the refreshlight.

11. Examination apparatus of claim 9, adapted as one of a two-dimensional x-ray imaging apparatus, a computed tomography apparatus, a coherent scatter computed tomography apparatus, and an x-ray examination apparatus for cardiac imaging, vascular imaging or universal radiography and fluoroscopy imaging.

12. Method for producing a partially transparent scintillator substrate-reflecting layer combination for a detector for examination of an object of interest with an examination apparatus, the method comprising the steps of:
providing a scintillator substrate;
depositing a reflecting layer on the scintillator substrate; and
providing a plurality of holes in the reflecting layer, the holes adapted for being transparent to a wavelength of refreshlight, such that the combination of scintillator substrate and reflecting layer is partially transparent to the wavelength of the refreshlight;
wherein the reflecting layer is adapted for reflecting a fraction of light generated in a scintillator towards a sensor array.

13. The method of claim 11, further comprising the step of:
changing a surface structure of the scintillator substrate on a side where a scintillator will be grown, resulting in a surface roughness for preventing a delamination of the scintillator substrate during use of the detector.

14. Method for producing a partially transparent substrate-reflecting layer combination for a detector for examination of an object of interest with an examination apparatus is provided, the method comprising the steps of:
providing a sensor array substrate;
depositing a sensor array on the sensor array substrate;
depositing a scintillator on the sensor array; and
providing a reflecting layer on the scintillator.

15. Method of claim 14, wherein the reflecting layer is adapted as one of a mirror or as white paint with small holes.
